(19) United States
(12) Patent Application Publication
(10) Pub. No.: US 2008/0006989 A1
(43) Pub. Date: Jan. 10, 2008

(54) TRANSPORTING DEVICE

(75) Inventors: Akira MASAKI, Noda-Shi (JP); Yoshitaka KATAOKA, Noda-Shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 11/770,595

(22) Filed: Jun. 28, 2007

(30) Foreign Application Priority Data
Jun. 30, 2006 (JP) 2006-180693

(51) Int. Cl. B65H 45/20; B41F 13/56; B65H 29/68

(52) U.S. Cl. 271/202

(57) ABSTRACT

Provided is a transporting device including: upstream-side upper and lower belts that transport a signature; downstream-side upper and lower belts that communicate with the upstream-side upper and lower belts, that run at a slower speed than that of the upstream-side upper and lower belts, and that receive the signature from the upstream-side upper and lower belts to transport the signature; and slowdown wheels including stoppers that come out on the transporting path of the signature between the downstream-side upper and lower belts so as to abut on the forward edge portion of the signature in the transporting direction thereof, the transporting device provided with pressing cams including pressing surfaces that press the downstream-side lower belt towards the downstream-side upper belt while the stoppers of the slowdown wheels abut on the forward edge portion of the signature in the transporting direction thereof.

### BACKGROUND OF THE INVENTION

1. Field of the Invention

The present invention relates to a transporting device in which a sheet from upstream-side transporting means is received between a downstream-side upper belt and a downstream-side lower belt of downstream-side transporting means, the belts paired with each other and running at a slower speed than that of the upstream-side transporting means, and in which coming-out means is caused to come out on the transporting path of the sheet in the downstream-side transporting means so as to abut on the forward edge portion of the sheet in the transporting direction thereof. Particularly, the present invention is to be effectively applied to the case of transporting a signature folded by a folder provided to a rotary printing press or the like.

2. Description of the Related Art

In general, a rotary printing press is provided with a folder for folding printed web. Some folders are provided with a transporting device configured to reduce the transporting speed of a signature before the signature is caused to undergo the folding process. FIG. 5 shows an example of a transporting device provided to such a folder.

In FIG. 5, each of reference numerals 111 to 113 denotes a set of upstream-side upper rollers. Each of reference numerals 114 to 116 denotes a set of upstream-side lower rollers. Reference numeral 118 denotes a set of upstream-side upper belts, and reference numeral 119 denotes a set of upstream-side lower belts. Each of reference numerals 121 to 123 denotes a set of downstream-side upper rollers. Each of reference numerals 125 to 127 denotes a set of downstream-side lower rollers. Reference numeral 128 denotes a set of downstream-side upper belts. Reference numeral 129 denotes a set of downstream-side lower belts. Reference numeral 131 denotes a drive shaft. Reference numeral 132 denotes a set of disks, and reference numeral 133 denotes a set of stoppers.

A plurality of the upstream-side upper rollers 111 (112, 113) are rotatably mounted on an unillustrated support shaft, and are arranged at predetermined intervals in the axial direction. On the other hand, a plurality of the upstream-side lower rollers 114 (115, 116) are rotatably mounted on an unillustrated support shaft, and are arranged at the same intervals as those of each of the sets of the rollers 111 to 113 in the axial direction. Accordingly, each upstream-side lower roller 114 is positioned on the same vertical plane as that on which a corresponding one of each of the rollers 111 to 113 is positioned.

Each of the upstream-side upper belts 118 is looped on the corresponding upstream-side upper rollers 111 to 113, causing the corresponding rollers 111 to 113 to communicate with one another. Each of the upstream-side lower belts 119 is looped on the corresponding upstream-side lower rollers 114 to 116, causing the corresponding rollers 114 to 116 to communicate with one another. The upstream-side lower belts 119 face the respective upstream-side upper belts 118 so as to be capable of sandwiching a signature with the upstream-side upper belts 118.

A plurality of the downstream-side upper rollers 121 (122, 123) are rotatably mounted on an unillustrated support shaft in a manner that each downstream-side upper roller 121 is positioned on the vertical plane between adjacent two rollers of each set of the upstream-side upper rollers 111 to 113. Among them, only the rollers 121 are positioned more upstream than the upstream-side upper rollers 113. On the other hand, a plurality of the downstream-side lower rollers 125 (126, 127) are rotatably mounted on an unillustrated support shaft in a manner that each downstream-side lower roller 125 is positioned on the same vertical plane as that on which a corresponding one of each of the rollers 121 to 123 is positioned. Among them, only the downstream-side lower rollers 125 are positioned more upstream than the upstream-side lower rollers 116.

Each of the downstream-side upper belts 128 is looped on the corresponding downstream-side upper rollers 121 to 123, causing the corresponding rollers 121 to 123 to communicate with one another. Accordingly, a part of each downstream-side upper belt 128 on the upstream side enters between adjacent two of the upstream-side upper belts 118. In other words, the part on the upstream-side overlaps the upstream-side upper belts 118 in the horizontal direction. Each of the downstream-side lower belts 129 is looped on the corresponding downstream-side upper rollers 125 to 127, causing the corresponding rollers 125 to 127 to communicate with one another. Accordingly, a part of each downstream-side lower belt 129 on the upstream side enters between adjacent two of the upstream-side lower belts 119. In other words, the part on the upstream-side overlaps the upstream-side lower belts 119 in the horizontal direction. In this manner, the downstream-side lower belts 129 face the respective upstream-side upper belts 128 so as to be capable of sandwiching the signature with the upstream-side upper belts 128.

The drive shaft 131 is arranged to be positioned on the downstream side of the upstream-side lower rollers 116 in a portion surrounded by the downstream-side lower rollers 125 to 127. A plurality of the disks 132 are mounted on the drive shaft 131 in a manner that each disk 132 is positioned between adjacent two of the downstream-side lower belts 129. Each of the stoppers 133 stands on the outer peripheral surface of the corresponding disk 132 so that the stoppers 133 can protrude upward from between adjacent two of the downstream-side lower belts 129.

In such a transporting device, a signature is transported in the following manner. The upstream-side upper and lower belts 118 and 119 are caused to run at the same speed, while the downstream-side upper and lower belts 128 and 129 are caused to run at a predetermined speed slower than that of the belts 118 and 119, and concurrently the disks 132 are rotated. The signature held between, and transported by, the belts 118 and 119 is transferred to the belts 128 and 129. Then, the forward edge portion of the signature in the transporting direction thereof is caused to abut on the stoppers 133. Accordingly, the posture of the signature (the tilt with respect to the transporting direction) is corrected while the timing of transporting the signature is adjusted. As a result, the signatures are transported by the belts 128 and 129 in a state where the signatures are aligned with predetermined intervals (for example, refer to Japanese Examined Patent Publication No. Hei 02-062456, and Japanese Patent Application Laid-open Publication No. Hei 11-060056).

As described above, in a conventional transporting device, the signature transported from the upstream-side belts 118 and 119 is firstly transferred to the downstream-side belts 128 and 129 running at a speed slower than that of the belts 118 and 119. At this time, the forward edge portion of the signature in the transporting direction thereof is caused to abut on the stoppers 133 each coming out from between the corresponding adjacent two of the downstream-side lower belts 129. As a result, the tilt of the signature is corrected while the timing of the transporting the signature is adjusted. Accordingly, depending on the degree of the tilt of the signature and the timing of the transfer, the forward edge portion of the signature in the transporting direction thereof is sometimes damaged. This is because the forward edge portion is pressed against the edge portions of the stoppers 133 in the width direction due to the fictitious force at the time of the transporting of the signature by the belts 118 and 119.

Such a problem is not limited to the case of the above-described transporting device for transporting a signature folded by a folder provided to a rotary printing press. The problem, as in the case described above, may occur in the case of a transporting device described below. Specifically, a sheet from upstream-side transporting means is received between a downstream-side upper belt and a downstream-side lower belt, paired with each other, of downstream-side transporting means. The belts run at a speed slower than the upstream-side transporting means. Then, coming-out means is caused to protrude upward on the transporting path of the sheet in the downstream-side transporting means so as to abut on the forward edge portion of the sheet in the transporting direction thereof.

### SUMMARY OF THE INVENTION

In view of the above-described circumstances, an object of the present invention is to provide a transporting device in which the damaging of the forward edge portion of a sheet in the transporting direction thereof is reduced while the fictitious force of the sheet is also suppressed.

For solving the above-described problem, the present invention provides a transporting device including upstream-side transporting means, downstream-side transporting means, coming-out means and downstream-side-belt moving means. The upstream-side transporting means transports a sheet. The downstream-side transporting means communicates with the downstream side of the upstream-side transporting means, and includes downstream-side upper and lower belts paired with each other for receiving the sheet from the upstream-side transporting means. The belts run at a slower speed than that of the upstream-side transporting means. The coming-out means comes out on the transporting path of the sheet in the downstream-side transporting means so as to abut on the forward edge portion of the sheet in the transporting direction thereof. The downstream-side-belt moving means causes at least one of the downstream-side upper and lower belts of the downstream-side transporting means to move towards the other one while the coming-out means abuts on the forward edge portion of the sheet in the transporting direction thereof.

In addition, the transporting device according to the present invention provides the following features. Specifically, in the transporting device, the downstream-side transporting means includes a plurality of pairs of the downstream-side upper and lower belts arranged in the width direction of the belts. Moreover, the coming-out means comes out on the transporting path of the sheet from between adjacent two, in the width direction of the belts, of the plurality of pairs of the belts of the downstream-side transporting means.

Furthermore, the transporting device according to the present invention provides the following features. Specifically, the downstream-side-belt moving means includes a rotatable support shaft and a rotor. The rotor is supported by the support shaft, and includes a pressing surface for pressing one of the downstream-side upper and lower belts of the downstream-side transporting means.

In addition, the transporting device according to the present invention provides the following features. In the transporting device, the coming-out means includes a rotatable support shaft and a stopper member. The stopper member is supported by the support shaft, and is configured to come out on the transporting path of the sheet. Additionally, the support shaft of the coming-out means is the same as that of the downstream-side-belt moving means.

Moreover, the transporting device according to the present invention provides the following features. In the transporting device, the coming-out means and the downstream-side-belt moving means are arranged between upper and lower positions where the downstream-side lower belt of the downstream-side transporting means runs.

Furthermore, the transporting device according to the present invention provides the following features. In the transporting device, the pressing surface of the rotor of the downstream-side-belt moving means extends across the length of the sheet in the transporting direction thereof.

In addition, the transporting device according to the present invention provides the following features. In the transporting device, the pressing surface of the rotor of the downstream-side-belt moving means is arc-shaped.

Moreover, the transporting device according to the present invention provides the following features. In the transporting device, the rotor of the downstream-side-belt moving means includes a gap portion where the rotor does not press one of the downstream-side upper and lower belts of the downstream-side transporting means.

Furthermore, the transporting device according to the present invention provides the following features. In the transporting device, the gap portion of the rotor of the downstream-side-belt moving means is formed in a portion extending, from a position corresponding to a time when the coming-out means abuts on the forward edge portion of the sheet in the transporting direction thereof, to a position corresponding to a time before the coming-out means abuts on the forward edge portion.

In addition, the transporting device according to the present invention provides the following features. In the transporting device, the downstream-side-belt moving means does not cause the at-least-one of the belts to move towards the other one before the coming-out means abuts on the forward edge portion of the sheet in the transporting direction thereof.

Moreover, the transporting device according to the present invention provides the following features. In the transporting device, after the sheet is received between the downstream-side upper and lower belts of the downstream-side transporting means, the coming-out means abuts on the forward edge portion of the sheet in the transporting direction thereof so as to correct the posture of the sheet, and then the downstream-side-belt moving means causes the at-least-one of the belts to move towards the other one, causing the belts to hold the sheet.

Furthermore, the transporting device according to the present invention provides the following features. In the transporting device, the downstream-side-belt moving means moves in the transporting direction of the sheet.

In addition, the transporting device according to the present invention provides the following features. In the transporting device, the downstream-side-belt moving means rotates.

Moreover, the transporting device according to the present invention provides the following features. In the transporting device, the downstream-side-belt moving means rotates at substantially the same speed as that at which the belts of the downstream-side transporting means run.

Furthermore, the transporting device according to the present invention provides the following features. In the transporting device, the coming-out means moves in the transporting direction of the sheet.

In addition, the transporting device according to the present invention provides the following features. In the transporting device, the coming-out means rotates.

Moreover, the transporting device according to the present invention provides the following features. In the transporting device, the coming-out means rotates at substantially the same speed as that at which the belts of the downstream-side transporting means run.

Furthermore, the transporting device according to the present invention provides the following features. In the transporting device, the downstream-side upper belt and the downstream-side lower belt of the downstream-side transporting means include a space in between so as to allow the sheet to travel, in an area more upstream in the transporting direction of the sheet than a position where the coming-out means abuts on the forward edge portion of the sheet in the transporting direction thereof.

In addition, the transporting device according to the present invention provides the following features. In the transporting device, one of the belts is the downstream-side lower belt while the other one of the belts is the downstream-side upper belt.

### BRIEF DESCRIPTION OF THE DRAWINGS

The present invention will become more fully understood from the detailed description given hereinbelow and the accompanying drawings which are given by way of illustration only, and thus are not limitative of the present invention and wherein;

FIG. 1 shows a schematic view of a structure of a chief part of an embodiment of a transporting device according to the present invention;

FIG. 2 shows a plan view of the chief part of FIG. 1;

FIG. 3 shows an extracted and enlarged view of the chief part of FIG. 1;

FIG. 4 shows an explanatory view of an operation of the chief part of FIG. 1; and

FIG. 5 shows a schematic view of a structure of a chief part of an example of a conventional transporting device.

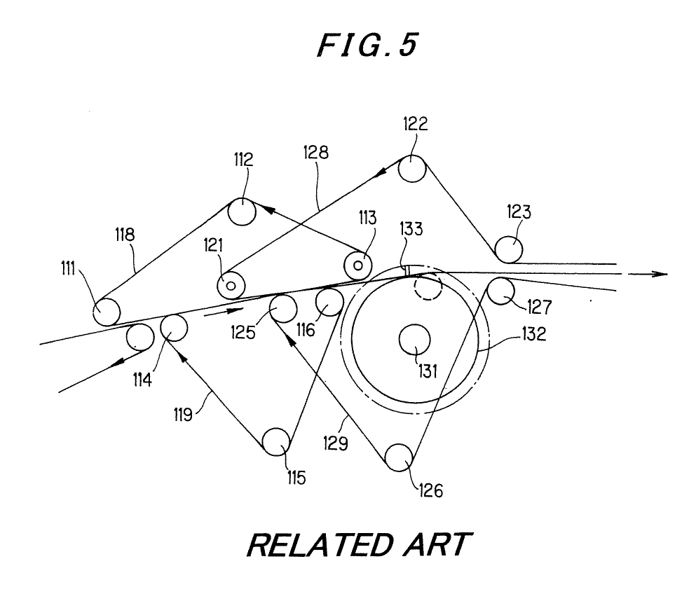

### DETAILED DESCRIPTION OF THE INVENTION

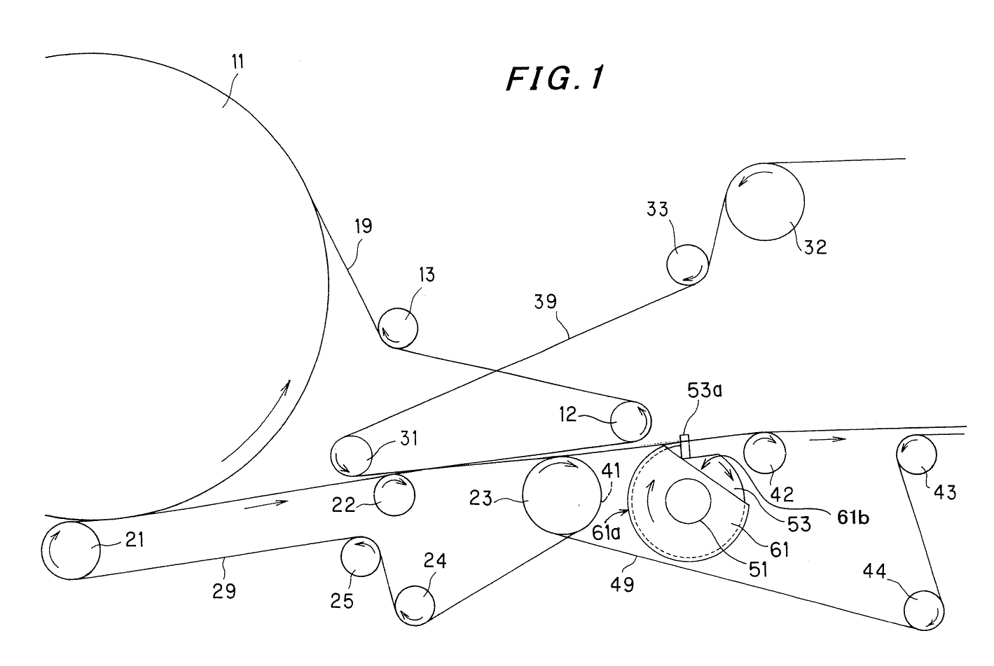

Descriptions will be given below of an embodiment in which a transporting device according to the present invention is applied to the case of transporting a signature folded by a folder provided to a rotary printing press or the like, with reference to FIGS. 1 to 4.

In FIG. 1, reference numeral 11 denotes a transfer cylinder, each of reference numerals 12 and 13 denotes a set of upstream-side upper rollers, reference numeral 19 denotes a set of upstream-side upper belts, each of reference numerals 21 to 25 denotes a set of upstream-side lower rollers, reference numeral 29 denotes a set of upstream-side lower belts, each of reference numerals 31 to 33 denotes a set of downstream-side upper rollers, reference numeral 39 denotes a set of downstream-side upper belts, each of reference numerals 41 to 44 denotes a set of downstream-side lower rollers, and reference numeral 49 denotes a set of downstream-side lower belts.

A plurality of the upstream-side upper rollers 12 (13) are rotatably mounted on an unillustrated support shaft, and are arranged at predetermined intervals in the axial direction. Each of the upstream-side upper belts 19 is looped on the transfer cylinder 11, and the corresponding rollers 12 and 13, causing the transfer cylinder 11, the corresponding rollers 12 and 13 to communicate with one another.

A plurality of the upstream-side lower rollers 21 (22 to 25) are rotatably mounted on an unillustrated support shaft, and are arranged at the same intervals as those of each of the sets of the rollers 12 and 13 in the axial direction. Accordingly, each upstream-side lower roller 21 is positioned on the same vertical plane as that on which a corresponding roller of each of the sets of the rollers 12 and 13 is positioned. Each of the upstream-side lower belts 29 is looped on the corresponding rollers 21 to 25, causing the corresponding rollers 21 to 25 to communicate with one another. The upstream-side lower belts 29 face, and are paired with, the respective upstream-side upper belts 19 so as to be capable of sandwiching a signature, which is a sheet, with the upstream-side upper belts 19.

A plurality of the downstream-side upper rollers 31 (32, 33) are rotatably mounted on an unillustrated support shaft so that each of the downstream-side upper rollers 31 is positioned between corresponding two of the upstream-side upper belts 19. The downstream-side upper rollers 31 are positioned more upstream than the upstream-side upper rollers 12 and 13. Each of the downstream-side upper belts 39 is looped on the corresponding downstream-side upper roller 31, the corresponding downstream-side upper roller 32, the corresponding downstream-side upper roller 33 and the like, causing these rollers 31 to 33 and other unillustrated downstream-side upper rollers to communicate with one another, respectively. Accordingly, a part of each downstream-side upper belt 39 on the upstream side enters between adjacent two of the upstream-side upper belts 19. In other words, the part on the upstream side overlaps the upstream-side upper belts 19 in the horizontal direction.

A plurality of the downstream-side lower rollers 41 (42 to 44) are rotatably mounted on an unillustrated support shaft in a manner that each downstream-side lower roller 41 is positioned on the same vertical plane as that on which a corresponding roller of each of the sets of the rollers 31 to 33 is positioned. Concurrently, the downstream-side lower rollers 41 are rotatably supported on the same support shaft as that of the upstream-side lower rollers 23. Each of the downstream-side lower belts 49 is looped on the corresponding downstream-side lower rollers 41 to 44 and other unillustrated downstream-side lower rollers, causing the corresponding rollers 41 to 44 and the others to communicate with one another. Accordingly, a part of each of the downstream-side lower belts 49 on the upstream side enters between adjacent two of the upstream-side lower belts 29. In other words, the part on the upstream side overlaps the upstream-side upper belts 29 in the horizontal direction. The downstream-side lower belts 49 face, and are paired with, the respective downstream-side upper belts 39 so as to be capable of sandwiching the signature with the downstream-side upper belts 39.

The downstream-side upper rollers 31 positioned on the most upstream side among the downstream-side upper rollers 31 to 33 are located so that a part of each downstream-side upper belt 39, the part positioned on the most upstream side, is located above the upstream-side upper belts 19. On the other hand, the upstream-side upper rollers 12 positioned on the most downstream side among the upstream-side upper rollers 12 and 13 are located so that a part of each upstream-side upper belt 19, the part positioned on the most downstream side, are located above the downstream-side upper belts 39.

In the present embodiment described above, the transfer cylinder 11, the upstream-side upper rollers 12 and 13, the upstream-side upper belts 19, the upstream-side lower rollers 21 to 25, the upstream-side lower belts 29 and the like constitute upstream-side transporting means. On the other hand, the downstream-side upper rollers 31 to 33, the downstream-side upper belts 39, the downstream-side lower rollers 41 to 44, the downstream-side lower belts 49 and the like constitute downstream-side transporting means.

As shown in FIGS. 1 to 3, a support shaft 51 is arranged in a vicinity of the downstream side of the downstream-side lower rollers 41, which is a vicinity of a portion where the upstream-side upper and lower belts 19 and 29 communicate with the downstream-side upper and lower belts 39 and 49. The two ends of the support shaft 51 are supported by frames 10a and 10b with bearings 52a and 52b interposed respectively in between, in a manner that the support shaft 51 can be rotated. A plurality of slowdown wheels 53 are supported by the support shaft 51 in a manner that each of the slowdown wheels 53 is positioned between adjacent two of the downstream-side lower belts 49 in the width direction thereof. Each slowdown wheel 53 is a wheel including a stopper 53a on the outer peripheral surface thereof. Each stopper 53a is configured to come out, at a constant frequency, on the transporting path of a signature 1, from between the adjacent two of the downstream-side lower belts 49 in the width direction thereof so as to abut on the forward edge portion of the signature 1 in the transporting direction thereof.

In addition, as shown in FIGS. 1 to 4, a plurality of pressing cams 61 are supported by the support shaft 51 in a manner that the pressing cams 61 are positioned below the respective downstream-side lower belts 49. Each pressing cam 61 is a rotor including an arc-shaped pressing surface 61a on the outer peripheral surface thereof. The pressing surfaces 61a are configured to press the respective downstream-side lower belts 49 at a constant frequency immediately after the stoppers 53a of the slowdown wheels 53 abut on the forward edge portion of the signature 1 in the transporting direction thereof. Accordingly, the pressing surfaces 61a cause the downstream-side upper and lower belts 39 and 49 paired with each other to hold the signature 1 in between, that is, the pressing surfaces 61a cause the downstream-side lower belts 49 to approach the respective downstream-side upper belts 39. The pressing surfaces 61a are also configured to be drawn apart from the respective downstream-side lower belts 49 at a constant frequency when the signature 1 is transported to a position more downstream in the transporting direction of the signature 1 than the positions of the slowdown wheels 53. Accordingly, the pressing surfaces 61a cause the signature 1 to be released from being held by the downstream-side upper and lower belts 39 and 49 paired with each other, that is, the pressing surfaces 61a cause the downstream-side upper and lower belts 39 and 49 to return to the original positions, respectively.

In other words, the slowdown wheels 53 and the pressing cams 61 are arranged between upper and lower positions where the downstream-side lower belts 49 run. The downstream-side upper and lower belts 39 and 49 have a space in between so as to allow the signature 1 to travel, in an area more upstream in the transporting direction of the signature 1 than a position where the stoppers 53a of the slowdown wheels 53 abut on the forward edge portion of the signature 1 in the transporting direction thereof. In addition, on the pressing cams 61, the pressing surfaces 61a extend across the length of the signature 1 in the transporting direction thereof so that the pressing cams 61 also include the gap portions 61b. The gap portions 61b are formed, from first positions in the respective pressing cams 61, which first positions are supposed to be in contact with the downstream-side lower belts 49 when the stoppers 53a of the slowdown wheels 53 abut on the forward edge portion of the signature 1 in the transporting direction thereof, to second positions in the respective pressing cams 61, which second positions are supposed to be in contact with the downstream-side lower belts 49 at the time when the stoppers 53a abut on the forward edge portion.

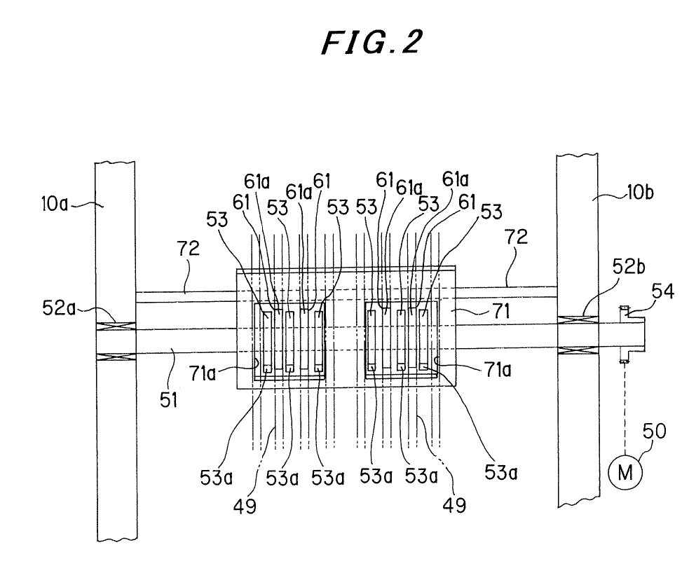

A gear 54 communicating with a motor 50 for driving the upstream-side upper and lower belts 39 and 49 is mounted on a shaft end (the right side in FIG. 2) of the support shaft 51. Accordingly, the driving of the motor 50 causes the slowdown wheels 53 and the pressing cams 61 to rotate at substantially the same circumferential speed as the running speed of the downstream-side upper and lower belts 39 and 49.

In other words, the slowdown wheels 53 and the pressing cams 61 rotate in the manner of moving in the transporting direction of the signature 1 at substantially the same speed as that at which the downstream-side upper and lower belts 39 and 49 run.

In the present embodiment described above, the motor 50, the support shaft 51, the bearings 52a and 52b, the slowdown wheels 53 and the like constitute coming-out means, while the motor 50, the support shaft 51, the bearings 52a and 52b, the pressing cams 61 and the like constitute downstream-side-belt moving means.

It should be noted that, in FIG. 2, reference numerals 71 and 72 denote a guide table and a support beam, respectively. The guide table 71 is arranged below the downstream-side lower belts 49, and includes holes 71a where the slowdown wheel 53 and the pressing cams 61 pass through. The support beam 72 supports the guide table 71 to and between the frames 10a and 10b.

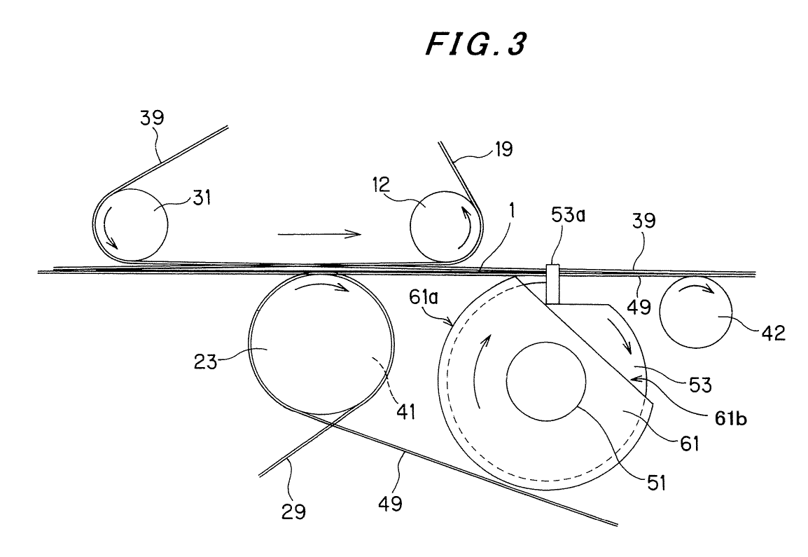

In the transporting device according to the present embodiment described above, the upstream-side upper and lower belts 19 and 29 are caused to run at the same speed, while the downstream-side upper and lower belts 39 and 49 are caused to run at a speed slower than that of the belts 19 and 29. Concurrently, the support shaft 51 is rotated. Accordingly, the signature 1, held between, and thus transported by, the belts 19 and 29 is transferred to between the belts 39 and 49, while the forward edge portion of the signature 1 in the transporting direction thereof abuts on the stoppers 53a of the slowdown wheels 53, each stopper 53a having protruded from between adjacent two of the downstream-side lower belts 49 in the width direction thereof. Accordingly, the posture of the signature 1 (the tilt of the signature 1 with respect to the transporting direction thereof) is corrected, while the timing of transporting the signature 1 is adjusted (refer to FIG. 3).

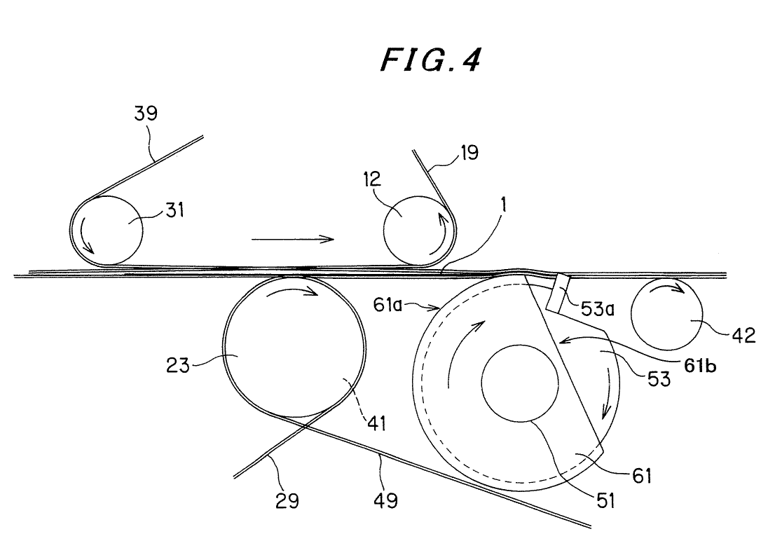

Immediately after the forward edge portion of the signature 1 in the transporting direction thereof abuts on the stoppers 53a of the slowdown wheels 53, the pressing surfaces 61a of the pressing cams 61 are brought into contact with the respective downstream-side lower belts 49, so as to press the downstream-side lower belts 49 upwards. Accordingly, the downstream-side lower belts 49 are caused to approach the respective downstream-side upper belts 39. As a result, the downstream-side upper belts 39 and the downstream-side lower belts 49 hold, in between, a portion of the signature 1 posterior in the transporting direction thereof to the forward edge portion of the signature 1 in the transporting direction thereof (refer to FIG. 4).

Subsequently, the stoppers 53a of the slowdown wheels 53 are separated from the forward edge portion of the signature 1 in the transporting direction thereof. Then, the signature 1 is transported to a position more downstream in the transporting direction thereof than the portions of the slowdown wheels 53. Accordingly, the pressing surfaces 61a of the pressing cams 61 pass over so as to return the downstream-side lower belts 49 to the original portions.

Thereafter, the slowdown wheels 53 and the pressing cams 61 repeat the above-described operations.

In other words, the pressing cams 61 do not cause the downstream-side lower belts 49 to move towards the downstream-side upper belts 39 before the stoppers 53a of the slowdown wheels 53 abut on the forward edge portion of the signature 1 in the transporting direction thereof. After the signature 1 is transferred between the downstream-side upper and lower belts 39 and 49, the stoppers 53a of the slowdown wheels 53 abut on the forward edge portion of the signature 1 in the transporting direction thereof so that the posture of the signature 1 is corrected. After that, the pressing cams 61 cause the downstream-side lower belts 49 to move towards the downstream-side upper belts 39 so that the signature 1 is held between the downstream-side upper and lower belts 39 and 49. In short, in the transporting device according to the present embodiment, while the stoppers 53a of the slowdown wheels 53 are abutting on the forward edge portion of the signature 1 in the transporting direction thereof, the downstream-side upper belts 39 and the corresponding downstream-side lower belts 49 hold the signature 1 in between.

For this reason, in the transporting device according to the present embodiment, it is possible to suppress, to the required minimum, the fictitious force which is caused by the upstream-side upper and lower belts 19 and 29, and which acts on the forward edge portion of the signature 1 in the transporting direction thereof.

Accordingly, in the transporting device according to the present embodiment, it is possible to suppress the damaging of the forward edge portion of the signature 1 in the transporting direction thereof due to the hitting of the stoppers 53a of the slowdown wheels 53 against the forward edge portion. At the same time, in the transporting device according to the present embodiment, it is possible to transport the signature 1 with no tilt with the belts 39 and 49.

In addition, on the pressing cams 61, the pressing surfaces 61a extend for a length equal to that of the signature 1 in the transporting direction thereof so that the pressing cams 61 also include the gap portions 61b. The gap portions 61b extend, from a position corresponding to a time when the stoppers 53a of the slowdown wheels 53 abut on the forward edge portion of the signature 1 in the transporting direction thereof, to a position corresponding to a time before the stoppers 53a abut on the forward edge portion. Accordingly, each pressing cam 61 does not press the downstream-side lower belts 49 in the portion where the gap portion 61b is provided. For this reason, it is possible to transport the signature 1 to the position where the signature 1 abuts on the stoppers 53a of the slowdown wheels 53 without any problem. At the same time, it is possible to hold the signature 1 transported by the downstream-side upper and lower belts 39 and 49 along and throughout the length of the signature 1 in the transporting direction thereof. These make it possible to stably transfer the signature 1 from the upstream-side upper and lower belts 19 and 29 running at a fast speed to the downstream-side upper and lower belts 39 and 49 running at a slow speed.

Moreover, the downstream-side upper and lower belts 39 and 49 have a space in between so as to allow the signature 1 to travel, in an area more upstream in the transporting direction of the signature 1 than a position where the stoppers 53a of the slowdown wheels 53 abut on the forward edge portion of the signature 1 in the transporting direction thereof. Concurrently, the pressing cams 61 include the gap portions 61b. Accordingly, the signature 1 is prevented from being constrained when the posture of the signature 1 is corrected by causing the forward edge portion of the signature 1 in the transporting direction thereof to abut on the stoppers 53a of the slowdown wheels 53. As a result, it is possible to securely correct the posture of the signature 1 to the normal position without causing a crease, damage and the like to the signature 1.

Furthermore, since the pressing cams 61 rotate at substantially the same speed as the running speed of the downstream-side lower belts 49, it is possible to suppress abrasion of the downstream-side lower belts 49.

Incidentally, in the present embodiment, employed are the pressing cams 61 including the pressing surfaces 61a for pressing the downstream-side lower belts 49 at a predetermined period immediately after the stoppers 53a of the slowdown wheels 53 abut on the forward edge portion of the signature 1 in the transporting direction thereof. It is also possible to employ pressing cams including pressing surfaces for pressing the downstream-side lower belts 49 at a predetermined period while the stoppers 53a of the slowdown wheels 53 abut on the forward edge portion of the signature 1 in the transporting direction thereof. This also makes it possible to suppress the damaging of the forward edge portion of the signature 1 in the transporting direction thereof due to the hitting of the stoppers 53a of the slowdown wheels 53 against the forward edge portion. At the same time, it is also possible to transport the signature 1 with no tilt with the downstream-side upper and lower belts 39 and 49. However, since the following effect can be obtained, it is most preferable to employ the pressing cams 61 including the pressing surfaces 61a for pressing the downstream-side lower belts 49 at a predetermined period immediately after the stoppers 53a of the slowdown wheels 53 abut on the forward edge portion of the signature 1 in the transporting direction thereof as in the case of the present embodiment. Specifically, employing such pressing cams makes it possible to suppress, to the required minimum, the fictitious force which is caused by the upstream-side upper and lower belts 19 and 29, and which acts on the forward edge portion of the signature 1 in the transporting direction thereof. Accordingly, it is possible to suppress, to the minimum, the damaging of the forward edge portion of the signature 1 in the transporting direction thereof due to the hitting of the stoppers 53a of the slowdown wheels 53 against the forward edge portion.

In addition, in the present embodiment, the pressing cams 61 employed therein have the following configuration. Specifically, the pressing surfaces 61a pass over so as to return the downstream-side lower belts 49 to the original positions when the signature 1 is transported to a position more downstream in the transporting direction of the signature 1 than the slowdown wheels 53. As another embodiment, it is also possible to employ, for example, pressing cams having the following configurations. Specifically, it is possible to employ pressing cams whose pressing surfaces pass over so as to return the downstream-side lower belts 49 to the original positions when the stopper 53a of the slowdown wheels 53 are separated from the forward edge portion of the signature 1 in the transporting direction thereof. Alternatively, it is also possible to employ pressing cams whose pressing surfaces pass over so as to return the downstream-side lower belts 49 to the original positions immediately after the downstream-side upper and lower belts 39 and 49 hold a portion of the signature 1 posterior in the transporting direction thereof to the forward edge portion of the signature 1 in the transporting direction thereof. In other words, any pressing cams can provide an operational effect similar to that of the case of the present embodiment as long as the pressing cams have the following configuration. Specifically, the pressing surfaces pass over so as to return the downstream-side lower belts 49 to the original positions during the period, from a time immediately after the downstream-side upper and lower belts 39 and 49 hold a portion of the signature 1 posterior in the transporting direction thereof to the forward edge portion of the signature 1 in the transporting direction thereof, to a time immediately before the stoppers 53a of the slowdown wheels 53 abut on the forward edge portion of the signature 1 in the transporting direction thereof.

Moreover, in the present embodiment, the descriptions have been given of the following case. Specifically, as the downstream-side-belt moving means, the pressing cams 61 including the arc-shaped pressing surfaces 61a on the outer peripheral side thereof, and supported by the support shaft 51. Then, the downstream-side lower belts 49 are caused to approach the respective downstream-side upper belts 39 so that the signature 1 is held between the downstream-side upper belts 39 and the corresponding downstream-side lower belts 49. However, for example, another example as described below is also possible. Specifically, an air cylinder in which a pressing roller is rotationally supported to an end portion of a rod is employed as the downstream-side-belt moving means. The pressing roller is brought into contact with the downstream-side lower belts 49 extending the rod. Accordingly, the downstream-side lower belts 49 are pressed upwards so as to approach the downstream-side upper belts 39. As a result, the downstream-side upper belts 39 and the corresponding downstream-side lower belts 49 hold the signature 1 in between.

Furthermore, in the present embodiment, the downstream-side lower belts 49 are pressed upwards so as to approach the downstream-side upper belts 39, so that the downstream-side upper belts 39 and the corresponding downstream-side lower belts 49 hold the signature 1 in between. As another embodiment, the following configurations are also possible. Specifically, the downstream-side upper belts 39 may be pressed downwards so as to approach the downstream-side lower belts 49, so that the downstream-side upper belts 39 and the corresponding downstream-side lower belts 49 hold the signature 1 in between. Alternatively, the downstream-side upper belts 39 may be pressed downwards while the downstream-side lower belts 49 are pressed upwards. Accordingly the downstream-side upper belts 39 and the corresponding downstream-side lower belts 49 approach to each other so as to hold the signature 1 in between.

In addition, in the present embodiment, the pressing cams 61 and the slowdown wheels 53 are mounted on the same support shaft 51. As another embodiment, for example, it is possible to mount the pressing cams 61 and the slowdown wheels 53 respectively on support shafts different from each other.

Moreover, in the present embodiment, the slowdown wheels 53 including the stoppers 53a on the outer peripheral surface thereof are mounted on the support shaft 51. As another embodiment, for example, wheels are omitted so that stopper members are attached directly to a support shaft with no wheel in between.

Furthermore, in the present embodiment, the plurality of sets of the upstream-side upper and lower belts 19 and 29 are arranged in the width direction thereof. In addition, the plurality of sets of the downstream-side upper and lower belts 39 and 49 are arranged in the width direction thereof in a manner that each pair of the downstream-side upper and lower belts 39 and 49 is positioned between the corresponding adjacent two of the sets of the upstream-side upper and lower belts 19 and 29. Then each of the stoppers 53a of the slowdown wheels 53 is configured to protrude from between the corresponding adjacent two of the downstream-side upper and lower belts 39 and 49 in the width direction thereof. As another embodiment, for example, the following configuration is possible. Specifically, two sets of upstream-side upper and lower belts are arranged in the width direction. In addition, each pair of downstream-side upper and lower belts are arranged to be positioned between the two sets of the upstream-side upper and lower belts adjacent to each other in the width direction. Then, a stopper of a slowdown wheel is configured to protrude on the transporting path of the signature 1 at the most upstream portion of the downstream-side lower belt in the transporting direction.

In addition, in the present embodiment, descriptions have been given of the case where the present invention is applied to the transporting device for transporting the signature folded by the folder provided to the rotary printing press or the like. The transporting device according to the present invention is not limited to this case. The present invention may be applied to any transporting device as the case of the present embodiment, as long as the transporting device is configured in the following manner. Specifically, a sheet from upstream-side transporting means is received between the downstream-side upper and lower belts paired with each other, the belts running at a speed slower than that of the upstream-side transporting means. At the same time, coming-out means is caused to come out on the transporting path of the sheet of the downstream-side transporting means, and is caused to abut on the forward edge portion of the sheet in the transporting direction thereof.

In the transporting device according to the present invention, the coming-out means moves at least one of the downstream-side upper and lower belts towards the other one, while the downstream-side-belt moving means abuts on the forward-side edge portion of the sheet in the transporting direction thereof. Accordingly, it is possible to suppress, to the required minimum, the fictitious force which is caused by the upstream-side transporting means, and which acts on the forward edge portion of the sheet in the transporting direction thereof. As a result, it is possible to suppress the damaging of the forward edge portion of the sheet in the transporting direction thereof due to the hitting of the coming-out means against the forward edge portion. At the same time, it is also possible to transport the sheet with no tilt with the downstream-side upper and lower belts.

When the transporting device according to the present invention is applied, for example, to a case where a signature folded by a folder provided to a rotary printing press is transported, it is possible to suppress the damaging of the forward edge portion of the signature in the transporting direction thereof. Accordingly, it is significantly effective to utilize the transporting device according to the present invention in the printing industry and the like.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A transporting device, comprising:
upstream-side transporting means that transports a sheet;
downstream-side transporting means that communicates with the downstream side of the upstream-side transporting means, and that includes downstream-side upper and lower belts paired with each other for receiving the sheet from the upstream-side transporting means, the belts running at a slower speed than that of the upstream-side transporting means;
coming-out means that comes out on the transporting path of the sheet in the downstream-side transporting means so as to abut on the forward edge portion of the sheet in the transporting direction thereof; and
downstream-side-belt moving means that causes at least one of the downstream-side upper and lower belts of the downstream-side transporting means to move towards the other one while the coming-out means abuts on the forward edge portion of the sheet in the transporting direction thereof.

2. The transporting device according to claim 1 wherein
the downstream-side transporting means includes a plurality of pairs of the downstream-side upper belts and the downstream-side lower belts arranged in the width direction of the belts, and
the coming-out means comes out on the transporting path of the sheet from between adjacent two, in the width direction of the belts, of the plurality of pairs of the belts of the downstream-side transporting means.

3. The transporting device according to claim 1 wherein
the downstream-side-belt moving means includes:
a rotatable support shaft; and
a rotor that is supported by the support shaft, and that includes a pressing surface for pressing one of the downstream-side upper and lower belts of the downstream-side transporting means.

4. The transporting device according to claim 3 wherein
the coming-out means includes: a rotatable support shaft; and a stopper member that is supported by the support shaft, and that is configured to come out on the transporting path of the sheet, and
the support shaft of the coming-out means is the same as that of the downstream-side-belt moving means.

5. The transporting device according to claim 4 wherein the coming-out means and the downstream-side-belt moving means are arranged between upper and lower positions where the downstream-side lower belt of the downstream-side transporting means runs.

6. The transporting device according to claim 3 wherein the pressing surface of the rotor of the downstream-side-belt moving means extends across the length of the sheet in the transporting direction thereof.

7. The transporting device according to claim 3 wherein the pressing surface of the rotor of the downstream-side-belt moving means is arc-shaped.

8. The transporting device according to claim 3 wherein the rotor of the downstream-side-belt moving means includes a gap portion where the rotor does not press the one of the downstream-side upper and lower belts of the downstream-side transporting means.

9. The transporting device according to claim 8 wherein the gap portion of the rotor of the downstream-side-belt moving means is formed in a portion extending, from a position corresponding to a time when the coming-out means abuts on the forward edge portion of the sheet in the transporting direction thereof, to a position corresponding to a time before the coming-out means abuts on the forward edge portion.

10. The transporting device according to claim 1 wherein the downstream-side-belt moving means does not cause the at-least-one of the belts to move towards the other one before the coming-out means abuts on the forward edge portion of the sheet in the transporting direction thereof.

11. The transporting device according to claim 1 wherein after the sheet is received between the downstream-side upper and lower belts of the downstream-side transporting means, the coming-out means abuts on the forward edge portion of the sheet in the transporting direction thereof so as to correct the posture of the sheet, and then the downstream-side-belt moving means causes, at least, the at-least-one of the belts to move towards the other one, causing the belts to hold the sheet.

12. The transporting device according to claim 1 wherein the downstream-side-belt moving means moves in the transporting direction of the sheet.

13. The transporting device according to claim 1 wherein the downstream-side-belt moving means rotates.

14. The transporting device according to claim 13 wherein the downstream-side-belt moving means rotates at substantially the same speed as that at which the belts of the downstream-side transporting means run.

15. The transporting device according to claim 1 wherein the coming-out means moves in the transporting direction of the sheet.

16. The transporting device according to claim 1 wherein the coming-out means rotates.

17. The transporting device according to claim 16 wherein the coming-out means rotates at substantially the same speed as that at which the belts of the downstream-side transporting means run.

18. The transporting device according to claim 1 wherein the downstream-side upper and lower belts of the downstream-side transporting means have a space in between so as to allow the sheet to travel, in an area more upstream in the transporting direction of the sheet than a position where the coming-out means abuts on the forward edge portion of the sheet in the transporting direction thereof.

19. The transporting device according to claim 1 wherein
one of the belts is the downstream-side lower belt while the other one of the belts is the downstream-side upper belt.
